(19) United States
(12) Patent Application Publication
(10) Pub. No.: US 2002/0122523 A1
(43) Pub. Date: Sep. 5, 2002

(54) Method of treating large scale structural body

(75) Inventors: Masataka Aoki, Hitachi (JP); Kimihiro Kaimori, Mito (JP); Takahiro Adachi, Hitachi (JP)

Correspondence Address: CROWELL & MORING LLP, INTELLECTUAL PROPERTY GROUP, P.O. BOX 14300, WASHINGTON, DC, 20044-4300, US

(73) Assignee: HITACHI, LTD.

(21) Appl. No.: 09/942,842

(22) Filed: Aug. 31, 2001

(30) Foreign Application Priority Data
Oct. 20, 2000 (JP) 2000-326991

(51) Int. Cl. G21C 19/00

(52) U.S. Cl. 376/260

(57) ABSTRACT

A method of treating a large scale structural body is provided in which when carrying out and in the large scale structural body such as nuclear reactor pressure vessel and an internal reactor structural body from and to a nuclear reactor building, a used fuel pool and fuels stored inside thereof can be protected even if the large scale structural body drops by some cause. In the method of treating a large scale structural body in which an opening portion is provided at a roof of the nuclear reactor building and the large scale structural body is carried out/in through the opening portion; the carrying out/in of the large scale structural body is performed under a condition that a protective measure for the used fuel pool is provided in a nuclear reactor well.

### BACKGROUND OF THE INVENTION

1. Field of the Invention

The present invention relates to a method of carrying out a large scale structural body such as a nuclear reactor pressure vessel (herein below will be called as RPV) from a nuclear reactor building in a nuclear power plant and a method of carrying in a large scale structural body into a nuclear reactor building.

2. Conventional Art

A first prior art relating to a method of carrying out an RPV is disclosed in JP-A-6-230188 (1994), in which the RPV is hanged up in an air lock provided on a roof of a nuclear reactor building, then the RPV is fixed to the air lock by a fixing jig and the air lock and the RPV are displaced integrally under a condition that negative pressure is maintained within the air lock.

A second prior art relating to a method of carrying out an RPV is disclosed in JP-A-8-62368 (1996) in which a clean room which covers an opening potion of a roof on a nuclear reactor building is provided adjacent the nuclear reactor building and an internal reactor structure body, a control rod drive mechanism housing (hereinbelow will be called as CRD housing) and an RPV are integrally displaced into the clean room, thereafter, the same are carried out. The JP-A-8-62368 (1996) also discloses a method of carrying out the internal reactor structural body, the CRD housing, the RPV and a y shield integrally after displacing the same in the clean room.

A third prior art relating to a method of carrying out an RPV is disclosed in JP-A-9-145882 (1997) in which, while hanging up a large scale block integrating an internal reactor structural body, a CRD housing and an RPV, a cylindrical shield body is attached to the outer surface of the block and after sealing the large scale block by the shield body, the block is carried out from a nuclear reactor building.

The RPV dealt by the above conventional art is a large scale structural body having height of about 25 m, diameter of about 6 m and weight reaching upto about 1000 tons. When performing carrying out/carrying in work at the time of exchanging work of the RPV, it is required to keep a high standard of safety. For example, even when presuming a possible dropping of the RPV due to damage of such as a crane and hanging jig, it is required to take a measure to prevent beforehand a possible flying out of radio active materials from a nuclear reactor building to the outside thereof. In a boiling water type nuclear power generation plant, adjacent a nuclear reactor well in which the RPV is disposed a used fuel pool is arranged, in which an already use fuel is stored. Further, at the time of exchange work of the RPV all of the fuels loaded in the reactor are displaced into the used fuel pool before carrying out the RPV. By means of taking out all of the fuels in the reactor, a surface dosage rate of the RPV can be reduced and a radiation exposure quantity for workers can be reduced. Thereby, an RPV exchange work can be performed with a high level of safety.

Therefore, it is very important to establish a method of carrying out/in an RPV which can protect the used fuel pool and fuels in the used fuel pool, even if it is presumed a possible dropping of the RPV by some causes. However, the above first through third prior art do not take into account such problem.

### SUMMARY OF THE INVENTION

An object of the present invention is to provide a method of treating a large scale structural body in which when carrying out and in the large scale structural body such as an RPV and an internal reactor structural body from and to a nuclear reactor building, a used fuel pool and fuels stored inside thereof can be protected even if the large scale structural body drops by some cause.

In order to achieve the above object, a method of treating a large scale structural body according to one aspect of the present invention in which an opening portion is provided at a roof of a nuclear reactor building and the large scale structural body such as a nuclear reactor pressure vessel and an internal reactor structural body is carried out/in through the opening portion, the carrying out/in of the large scale structural body is performed under a condition that a protective measure for a used fuel pool is provided in a nuclear reactor well.

Preferably, the protective measure is provided with a guide used for carrying out/in of the large scale structural body or a cushioning member for relaxing an impact of the large scale structural body.

A method of treating a large scale structural body according to another aspect of the present invention in which an opening portion is provided at a roof of a nuclear reactor building and the large scale structural body such as a nuclear reactor pressure vessel and an internal reactor structural body is carried out/in through the opening portion, the carrying out/in of the large scale structural body is performed under a condition that the large scale structural body is inclined toward the opposite side of the used fuel pool.

A method of treating a large scale structural body according to still another aspect of the present invention in which an opening portion is provided at a roof of a nuclear reactor building and the large scale structural body such as a nuclear reactor pressure vessel and an internal reactor structural body is carried out/in through the opening portion, the carrying out/in of the large scale structural body is performed through a route away from a used fuel pool while enlarging the opening portion from the upper portion of the nuclear reactor well toward the opposite side of the used fuel pool.

Preferably, the carrying out/in of the large scale structural body is performed by making use of a large scale crane which is disposed outside the nuclear reactor building so that the large scale structural body never passes over the used fuel pool within the nuclear reactor building.

### BRIEF DESCRIPTION OF THE DRAWINGS

FIG. 1 is a flow chart showing an RPV exchanging method representing a first embodiment of the present embodiment;

FIG. 2 is a schematic vertical cross sectional view of a nuclear reactor building in a BWR plant to which the RPV exchange work is applied;

FIG. 3 is a plane view of FIG. 2;

FIG. 4 is a perspective view showing a state when a large scale crane is installed at the outside of a nuclear reactor building;

FIG. 5A is a schematic vertical cross sectional of a nuclear reactor building showing a state where a protective wall for a used fuel pool is disposed in a nuclear reactor well;

FIG. 5B is a detailed view of part A in FIG. 5A;

FIG. 6 is a plane view of an operation floor in FIG. 5A;

FIG. 7 is a schematic vertical cross sectional view of a nuclear reactor building showing a state where an RPV shield body is disposed above an RSW;

FIG. 8 is a schematic vertical cross sectional view showing a state where an RPV contacts to the RPV shield body;

FIG. 9 is a view taken along the arrowed line B-B in FIG. 8;

FIG. 10 is a schematic vertical cross sectional view of a nuclear reactor building showing a state where the RPV is now being carried out from the nuclear reactor building;

FIG. 11 is a schematic vertical cross sectional view showing a state where the RPV is hanged together with the RPV shield body;

FIG. 12A is a schematic vertical cross sectional view showing another state where the RPV is hanged together with the RPV shield body;

FIG. 12B is a view taken along the arrowed line C-C in FIG. 12A;

FIG. 13 is a schematic vertical cross sectional view of the nuclear reactor building showing a state where a new RPV is being carried into the nuclear reactor building;

FIG. 14 is a flow chart showing a major sequence of an RPV exchange method representing second embodiment of the present invention;

FIG. 15 is a cross sectional view of a nuclear reactor building showing a state where the RPV is being carried out while inclining the same toward the opposite side of the used fuel pool;

FIG. 16 is a partial cross sectional view showing a state where the RPV is hanged in an up-right manner;

FIG. 17 is a partial cross sectional view showing an exemplary state when the RPV is inclined;

FIG. 18 is a partial cross sectional view showing a state where the RPV is hanged in an up-right manner;

FIG. 19 is a partial cross sectional view showing another exemplary state when the RPV is inclined;

FIG. 20 is a partial cross sectional view showing still another exemplary state when the RPV is inclined;

FIG. 21 is a partial cross sectional view showing a further exemplary state when the RPV is inclined;

FIG. 22 is a partial cross sectional view showing a still further exemplary state when the RPV is inclined;

FIG. 23 is a schematic vertical cross sectional view of the nuclear reactor building showing a state where the RPV is being carried out through a carrying out route away from the used fuel pool; and

FIG. 24 is a plane view of the nuclear reactor building showing the carrying out route of the RPV in FIG. 23.

### DETAILED DESCRIPTION OF THE PREFERRED EMBODIMENTS

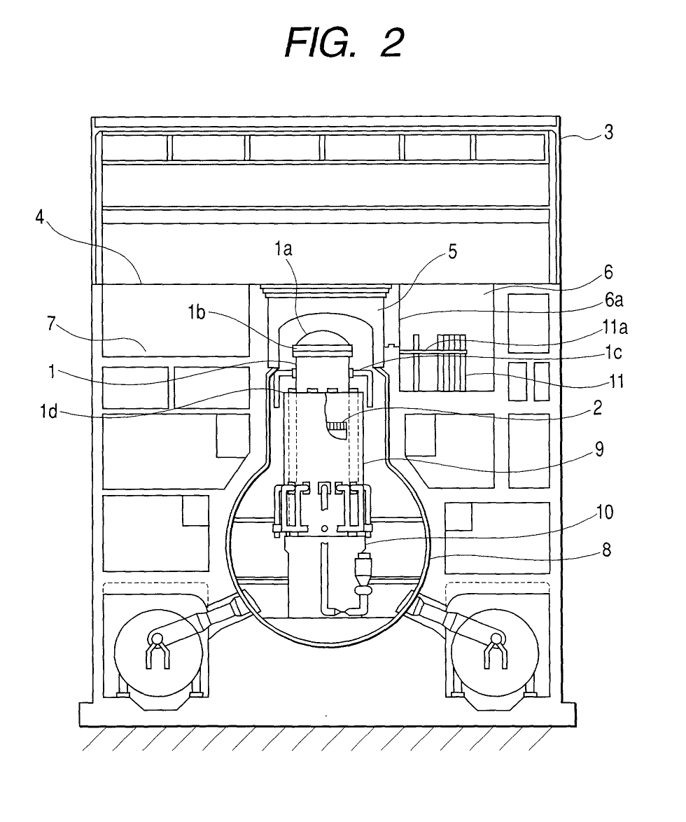

Hereinbelow, an embodiment of the present invention which is applied to a method of exchanging a nuclear reactor pressure vessel (RPV) will be explained with reference to the drawings. FIG. 2 is a schematic vertical cross sectional view of a nuclear reactor building of a boiling water type nuclear power generation plant (BWR plant) to which an RPV exchange work is applied.

In a nuclear reactor building 3, a nuclear reactor containment vessel (PCV) 8 which contains an RPV 1 is provided. Above the PCV 8, a nuclear reactor well 5 is provided which is used for filling shield water for shielding radioactive rays from a fuel 11 such as when exchanging the fuel (a fuel assembly) 11 and when taking out an internal reactor structural body (structural bodies in the RPV 1). Further, when exchanging the RPV 1, the RPV 1 is carried out/in from the nuclear reactor well 5. A machine and apparatus pool 7 which is for storing a taken out internal structural body 2 is provided adjacent the nuclear reactor well 5. A used fuel pool 6 for storing a used fuel 11 is provided adjacent the nuclear reactor well 5 and below an operation floor 4. In the used fuel pool 6 a fuel rack 11a for storing the used fuel 11 is provided.

The RPV 1 is disposed on the pedestal 10 and stands by itself while being secured by anchor bolts. The pedestal 10 is a structural body constructed by concrete and reinforcing bars so as to work as a base for the RPV 1. At the outside of the RPV 1 a nuclear reactor shield wall (hereinbelow, will be called as RSW) 9 is provided which is for shielding radioactive rays from such as the RPV 1 and the internal reactor structural body 2. The RSW 9 is a concrete structural body with steel plate frame of a thickness 600-700 mm. A top head 1a serving as an upper cover for the RPV 1 is secured by bolts to a flange 1b of the RPV 1. To the RPV 1 nozzles such as a main stream nozzle 1c are attached and are connected to pipings outside the RPV 1. Below the main steam nozzles 1c RPV stabilizer lugs 1d are attached which serve as an earth quake resistant support for the RPV 1 and are secured by an RPV stabilizer bracket provided at the upper portion of the RSW 9 and bolts.

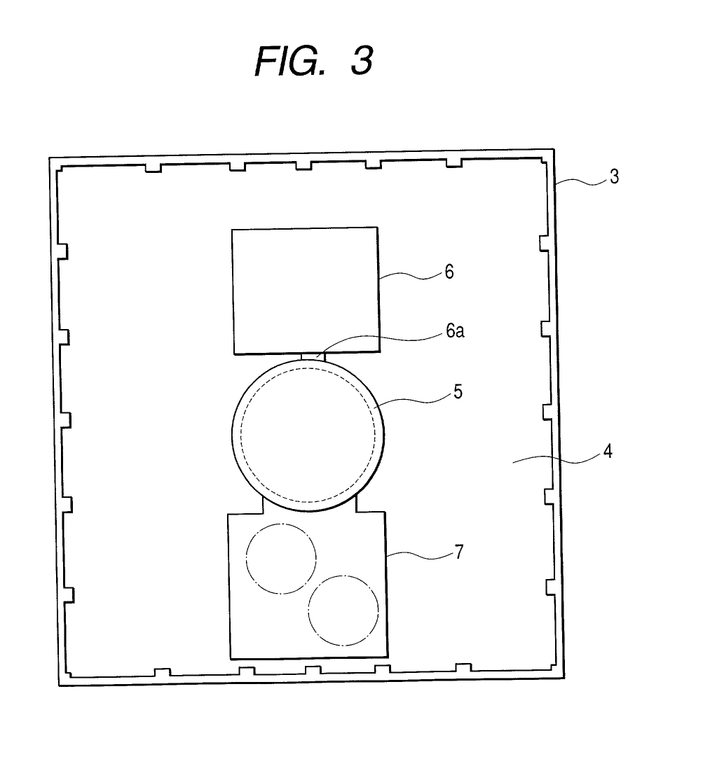

FIG. 3 is a plane layout view of the operation floor 4 in the nuclear reactor building 3, and corresponds to a plane view of FIG. 2. At the operation floor 4 in the nuclear reactor building 3 the fuel pool 6 and the machine and apparatus pool 7 are arranged at respective sides of the nuclear reactor well 5. Namely, the used fuel pool 6 is arranged at the opposite side of the machine and apparatus pool 7 with reference to the position of the nuclear reactor well 5. In the used fuel pool 6 water is filled so as to shield radioactive rays from the used fuel 11. Between the nuclear reactor well 5 and the used fuel pool 6 a gate 6a is provided, and when displacing a fuel in the reactor core into the fuel pool 6, the gate 6a is opened after filling up the nuclear reactor well 5, and the fuel is displaced under the water.

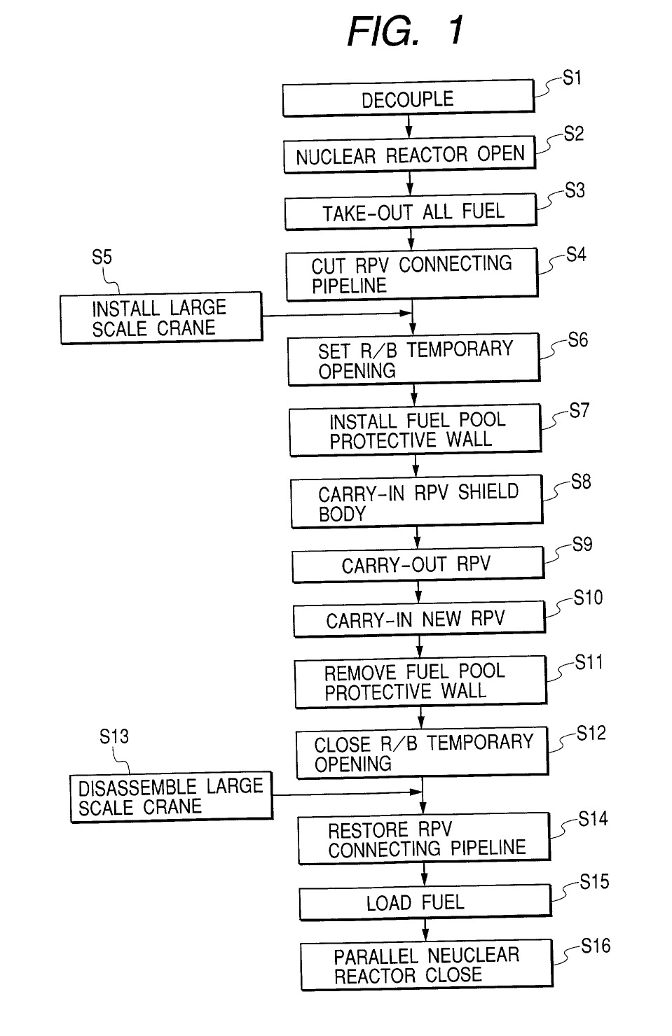

Now, an RPV exchange work representing a first embodiment of the present invention will be explained with reference to FIG. 1 through FIG. 9. In the present embodiment a protective wall is provided in the nuclear reactor well so that even if an RPV drops, the RPV is prevented to fall down to the side of the used fuel pool wall to break the fuel pool and to damage the fuel stored therein.

FIG. 1 is a flow chart showing an RPV exchange method of the first embodiment. At first, in step S1, a generator is decoupled to start periodical inspection of a nuclear power generation plant. In step S2, an opening work of the nuclear reactor is performed. In the nuclear reactor opening work a disassembling work of such as the RPV top head 1a and internal reactor machine and apparatus is performed. The disassembled internal reactor machine and apparatus is displaced to the machine and apparatus pool 7 adjacent the nuclear reactor well 5.

Subsequently, in step S3, a taking out work of all of the fuels in the reactor core is performed. In this taking out work of all fuels all of the fuels 11 loaded in the reactor core is displaced to the rack 11a in the used fuel pool 6. The method of fuel displacement is performed in such a manner that after filling up the nuclear reactor well 5 with water, the gate 6a between the nuclear reactor well 5 and the used fuel pool 6 is opened and the fuels 11 taken out from the reactor core is displaced under water. By means of taking out all of the fuels 11 in the reactor core, the surface dosage rate of the RPV 1 at the time of carrying out thereof can be reduced and a radiation exposure quantity to the workers can be reduced. After completing the fuel displacement the gate 6a is closed and the water in the nuclear reactor well 5 is drained.

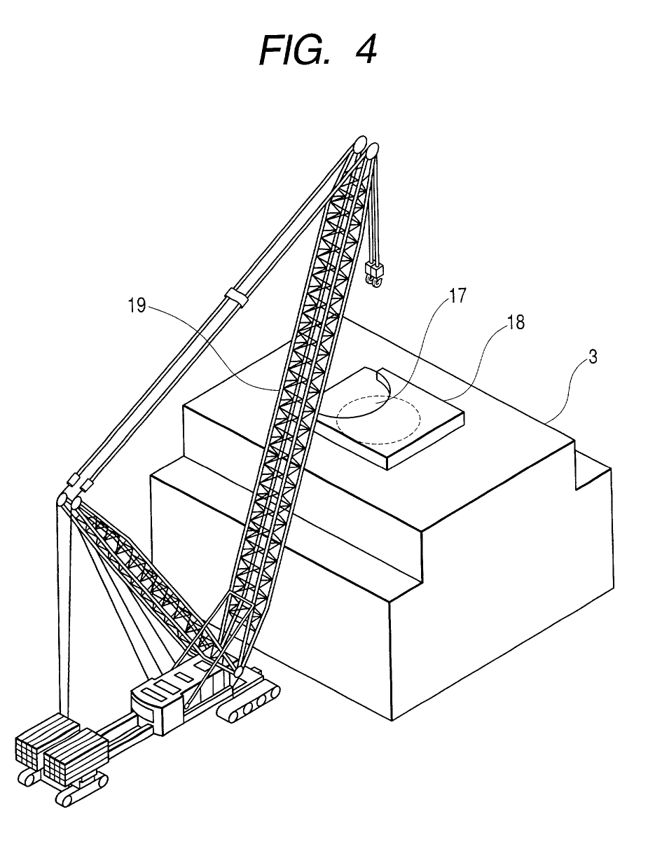

Subsequently, in step S4, a cutting work of pipings connected to RPV 1 is performed. In step S5 a large scale crane which is used for carrying out/in the RPV 1 is installed outside the nuclear reactor building. In step S6, an opening portion which permits carrying out/in of the RPV 1 is set on a roof of the nuclear reactor building (R/B). FIG. 4 is a perspective view showing a state where the large scale crane is installed outside the nuclear reactor building. 3 is the nuclear reactor building, 19 is the large scale crane, 17 (indicated by broken line) is a temporary opening portion and 18 is a shutter.

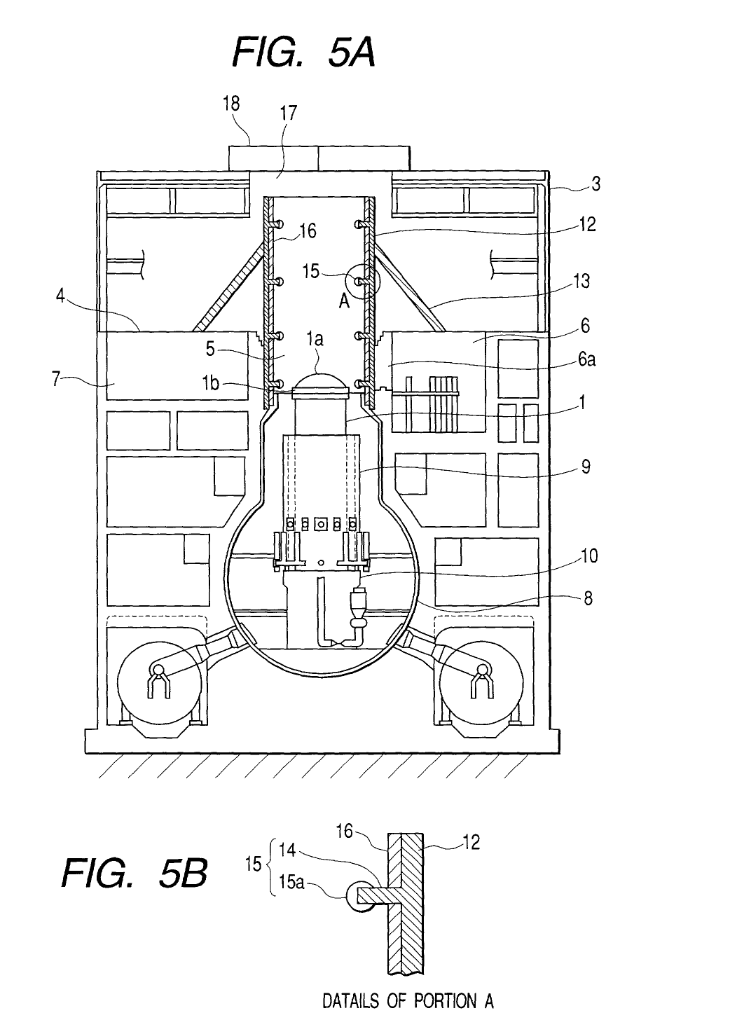

Then, in step S7, the protective wall (protective means) for the used fuel pool 6 is disposed in the nuclear reactor well 5. FIG. 5A is a schematic vertical cross sectional view of the nuclear reactor building 3 where the protective wall for the used fuel pool 6 is disposed within the nuclear reactor well 5. FIG. 5B is a detailed view of part A in FIG. 5A, and shows guides attached to the protective wall.

12 is the protective wall, 13 is a protection wall supporting member, 15 is a guide for guiding the carrying out/in of the RPV 1. The guide 15 is constituted by a pulley 15a, 16 is a cushion member attached inner side of the protective wall 12, 17 is the temporary opening portion arranged at the roof of the nuclear reactor building 3 and 18 is the shutter provided at the upper side of the temporary opening portion 17. The guide bracket 14 is provided with a structure (not shown) which permits to vary the length thereof (the projection height from inner face of the protective wall 12 toward the inside thereof). Thereby, when carrying in a new RPV which requires no attachment of a radioactive ray shielding body, the guide 15 can guide the new RPV in accordance with the outer configuration thereof.

The protective wall 12 is a cylindrical shape produced by such as steel and concrete, is carried in from the temporary opening portion 17 in the nuclear reactor building 3 under a divided state or an integral state by making use of a large scale crane 19 and is disposed around the inner wall face of the nuclear reactor well 5. Namely, the protective wall 12 is secured at the bottom of the nuclear reactor well 5 as well as secured by disposing the protective wall supporting member 13 onto the operation floor 1 (or a wall of the nuclear reactor well 5). Inside the protective wall 12, the guides 15 are attached. Through the provision of the guides 15 rocking of the RPV 1 at the time of carrying out/in thereof can be prevented and a carrying out/in thereof can be performed under a stable hanging up condition. Further, in order to relax an impact when the RPV 1 falls down toward the side of the protective wall 12 the cushion member 16 is attached on the inner side of the protective wall 12. Since it is sufficient if the protective wall 12 can protect the used fuel pool 6, gate 6a and the surroundings thereof, the protective wall 12 can be a simple structure of such as semicylindrical body and support columns.

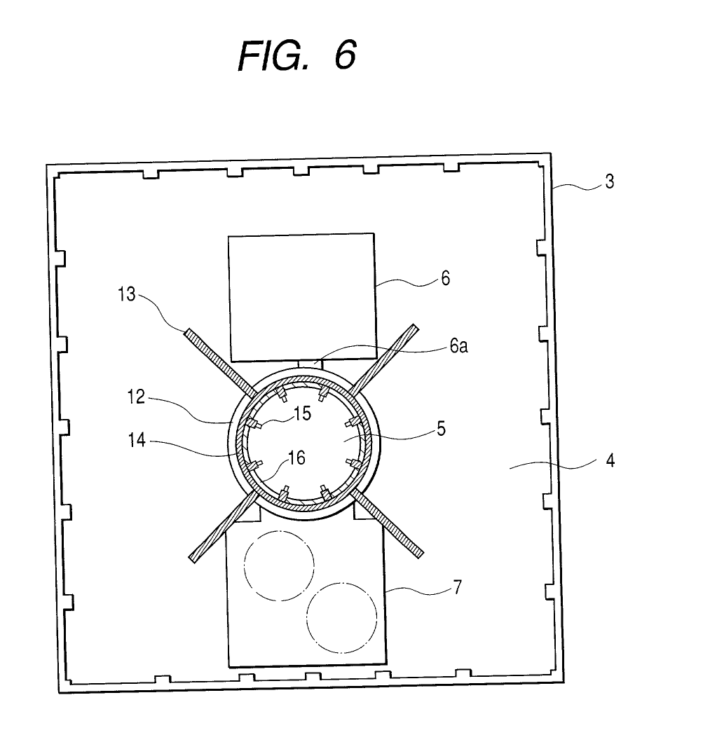

FIG. 6 is a plane view of the operation floor 4 of the nuclear reactor building 3 showing a state where the protective wall 12 is disposed in the nuclear reactor well 5. The protective wall support members 13 are disposed so as not to interfere with the used fuel pool 6 and the machine and apparatus pool 7.

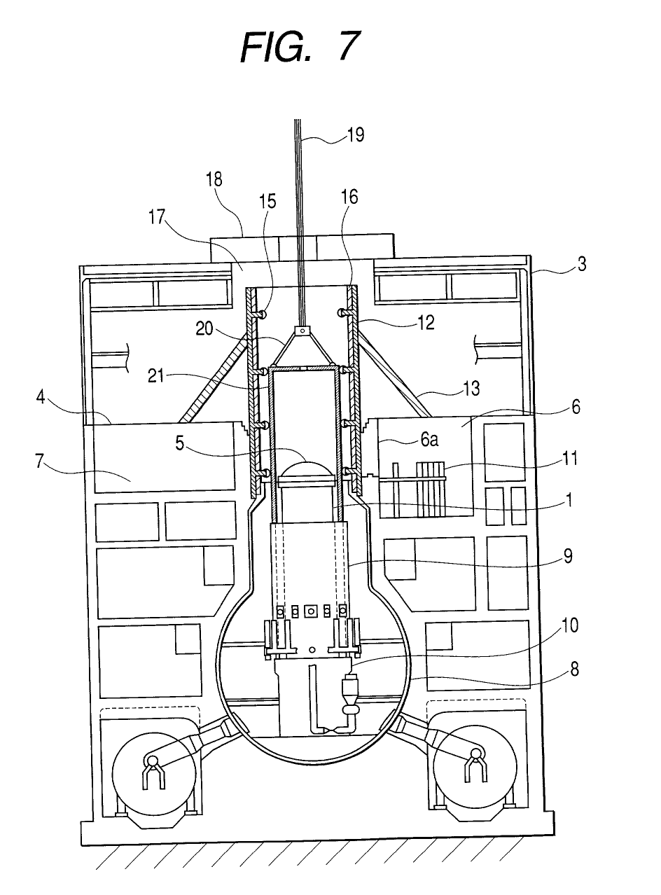

Subsequently, in step S8, an RPV shield body 21 is carried in into the nuclear reactor building 3 and is disposed on the upper portion of the RSW 9. FIG. 7 is a schematic vertical cross sectional view of the nuclear reactor building 3 showing a state where the RPV shield body 21 is disposed on the upper portion of the RSW 9. 21 is the RPV shield body, 19 is the large scale crane, and 20 is a hanging tool. The RPV shield body 21 is carried in by the large scale crane 19 through the temporary opening portion 17 and is temporarily placed on the RSW 9 through the protective wall 12. The RPV shield body 21 is for shielding the radioactive rays from the redioactivated RPV 1 and is a structural body, if made of steel, having thickness of 150-250 mm.

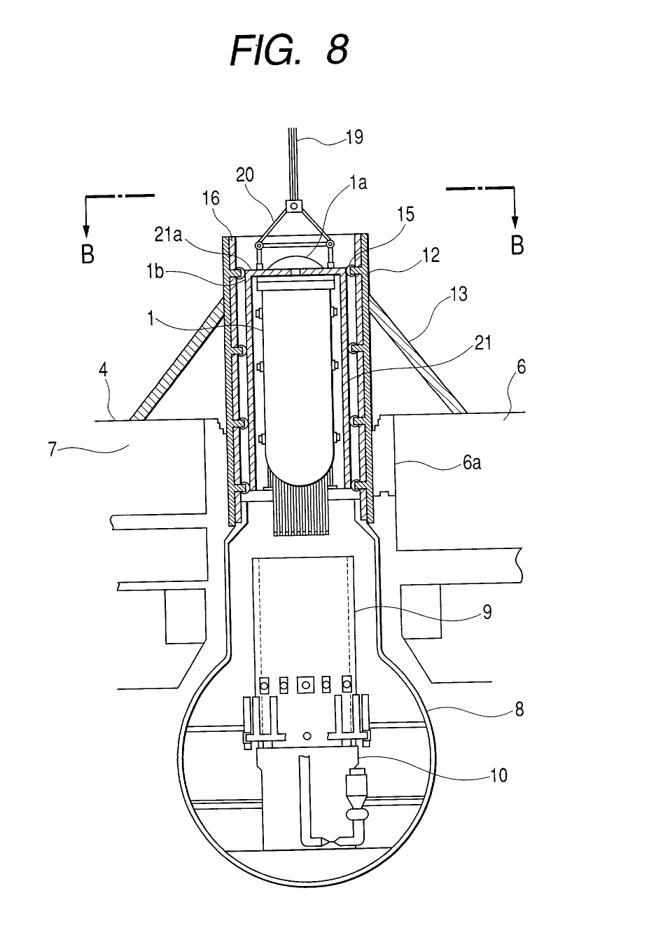

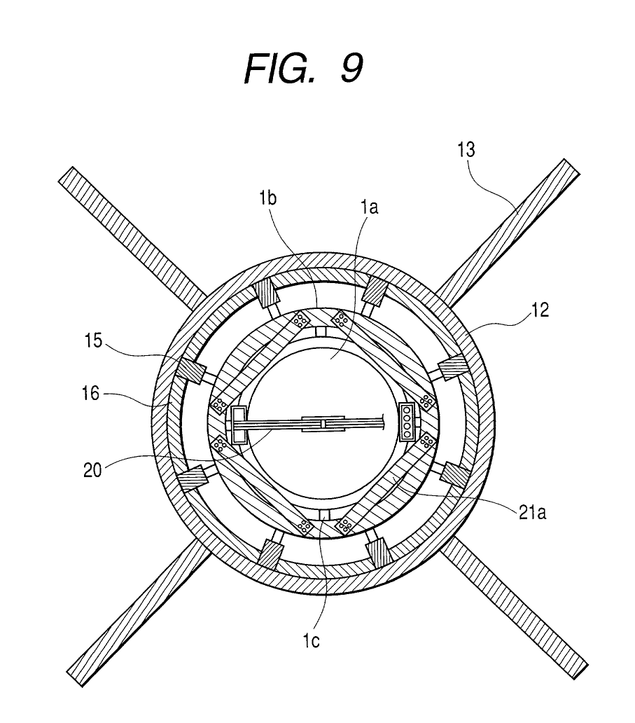

Subsequently, in step S9, the RPV 1 is hanged up and is carried out from the nuclear reactor building 3. FIG. 8 is a schematic vertical cross sectional view showing a state wherein the RPV 1 is hanged up by the large scale crane 19 and the upper face of the RPV 1 contacts the bottom face of the upper portion of the RPV shield body 21. FIG. 9 is a view taken along the arrowed line B-B in FIG. 8. 21a are beams attached at the upper portion (top portion) of the RPV shield body 21 and are provided at four positions in the circumferential direction thereof.

From an opening portion of the upper portion of the RPV shield body 21 the hanging tool 20 of the large scale crane 19 is hanged down, and is attached to the bolts on the frame 1b of the RPV 1, thereby, the RPV 1 is hanged up by the large scale crane 19. By hanging up the RPV 1 with the large scale crane 19 the flange 1b is caused to contact with the beams 21a of the RPV shield body 21. When hanging up the RPV 1 under this condition, the RPV 1 can be carried out under a condition that the RPV 1 is covered by the RPV shield body 21.

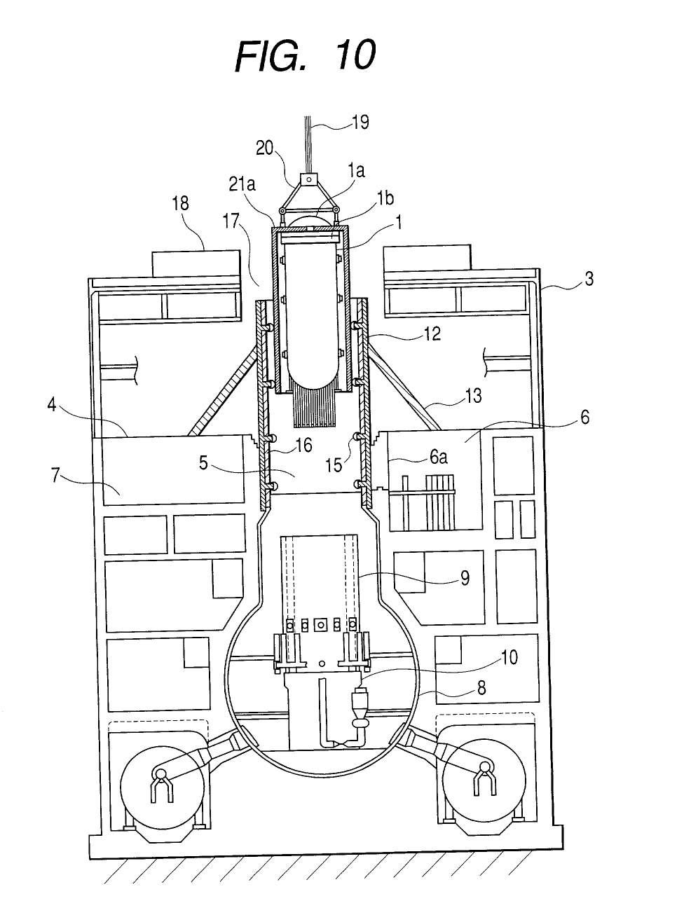

FIG. 10 is a schematic vertical cross sectional view showing a state where the RPV 1 is being carried out from the nuclear reactor building 3 while being hanged up. By hanging up the RPV 1 under a condition that the flange 1b contacts to the beams 21a, the RPV 1 and the RPV shield body 21 can be carried out together. Further, through the guides 15 provided at the protective wall 12, the both can be hanged up safely under a stable condition. Thus, after opening the shutter 18 provided for the temporary opening portion 17 arranged at the roof of the nuclear reactor building 3, the RPV 1 and the RPV shield body 21 is carried out from the nuclear reactor building 3.

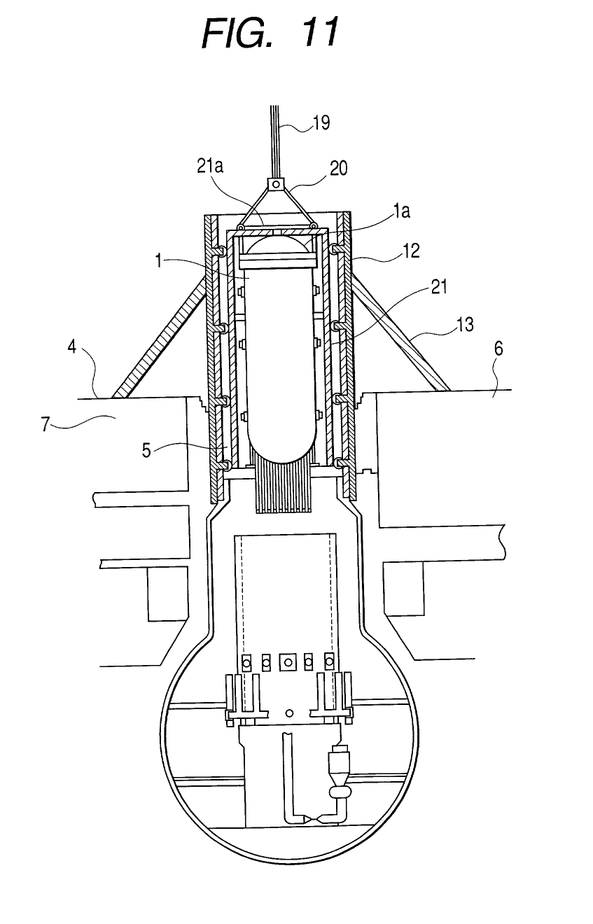

Now, other coupling methods of the RPV 1 and the RPV shield body will be explained. FIG. 11 is a schematic vertical cross sectional view showing a state where the top head 1a of the RPV 1 is caused to contact the upper portion of the RPV shield body 21, and the RPV 1 and RPV shield body 21 are hanged up together. If the height (length) of the RPV shield body 21 is increased according to the present modification in comparison with that in FIG. 10 and the top head 1a of RPV 1 is caused to contact the beams 21a attached to the upper portion of the RPV shield body 21, the RPV 1 and the RPV shield body 21 can be hanged up together.

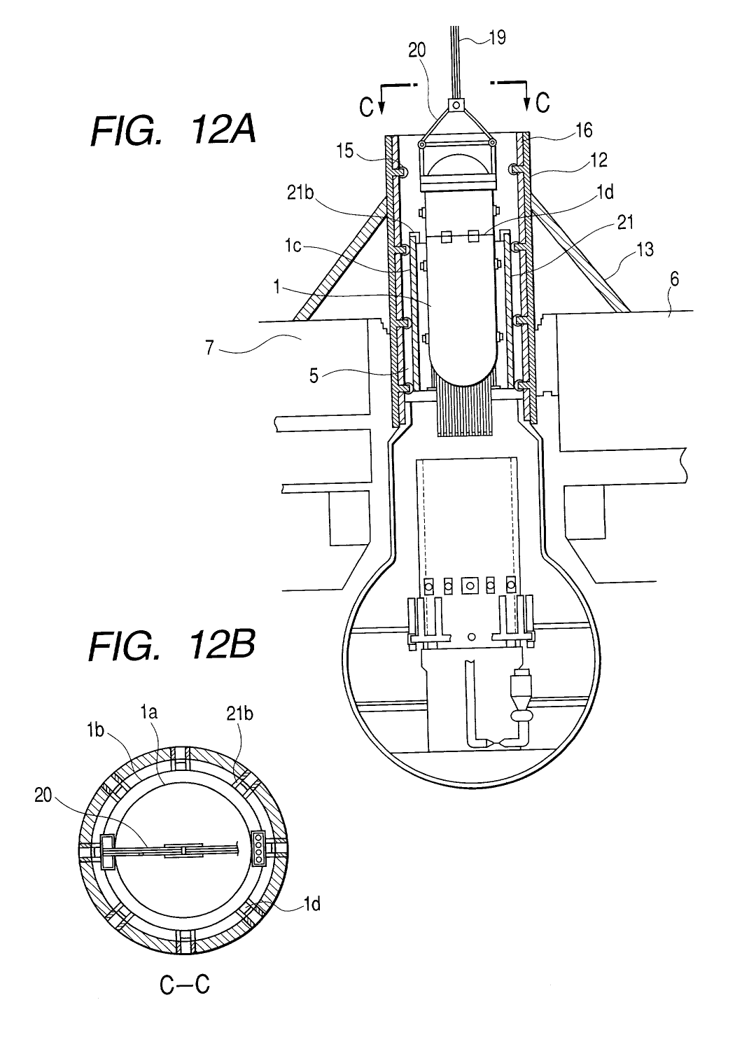

FIG. 12A is a schematic vertical cross sectional view showing a state where the stabilizer lugs id of the RPV 1 are caused to contact to the upper portion of the RPV shield body 21, and the RPV 1 and the RPV shield body 21 are hanged up together. FIG. 12B is a view taken along the arrowed line C-C in FIG. 12A. The present method can be used if the attachment height (length) of the RPV shield body 21 to the RPV 1 is acceptable at the portion near the stabilizer lugs 1d. 21b are brackets attached to the RPV shield body 21. The brackets 21b are secured by welding or bolts on the upper portion of the RPV shield body 21 at eight positions in the circumferential direction thereof. In this modification, when the RPV 1 is hanged up, the upper faces of the stabilizer lugs 1d are caused to contact the bottom faces of the brackets 21b of the RPV shield body 21, and the RPV 1 and the RPV shield body 21 can be hanged up together.

When carrying out the RPV 1 and the RPV shield body 21 together as has been explained above, it is presumed that the RPV 1 drops down in the nuclear reactor well 5 by some causes. In such instance, the RPV 1 drops together with the RPV shield body 21. However, the outer diameter of the RPV shield body 21 is larger than the inner diameter of the RSW 9 and contacts only to the RPV 1, the RPV shield body 21 stops on the RSW 9. Namely, only the RPV 1 drops to the upper portion of the pedestal 10 through the inside of the RSW 9. The dropped RPV 1 is prevented by the RSW 9 to fall down toward the used fuel pool 6. Thereby, a possible damaging of the used fuel pool 6 can be avoided.

Further, when the method of connecting the brackets 21a and the stabilizer lugs 1d by bolts is used, the strength of the bolts is set as follows, in that at first the bolts are required to sufficiently endure when the RPV 1 and RPV shield body 21 are hanged up together, further, the bolts are required to break down by an impact force when presuming a dropping of the RPV 1 and the dropping RPV shield body 21 hits on the upper portion of the RSW 9.

When the bolt strength is set as above, when the RPV 1 drops, the RPV shield body 21 is separated from the RPV 1 at the upper portion of the RSW 9 and the RPV 1 drops to the upper portion of the pedestal 10 through the inside of the RSW 9.

Accordingly, as in the same manner of contacting, the dropped RPV 1 is stopped inside the RSW 9 to prevent falling down toward the used fuel pool 6. Thereby, a possible damaging of the used fuel pool 6 can be avoided.

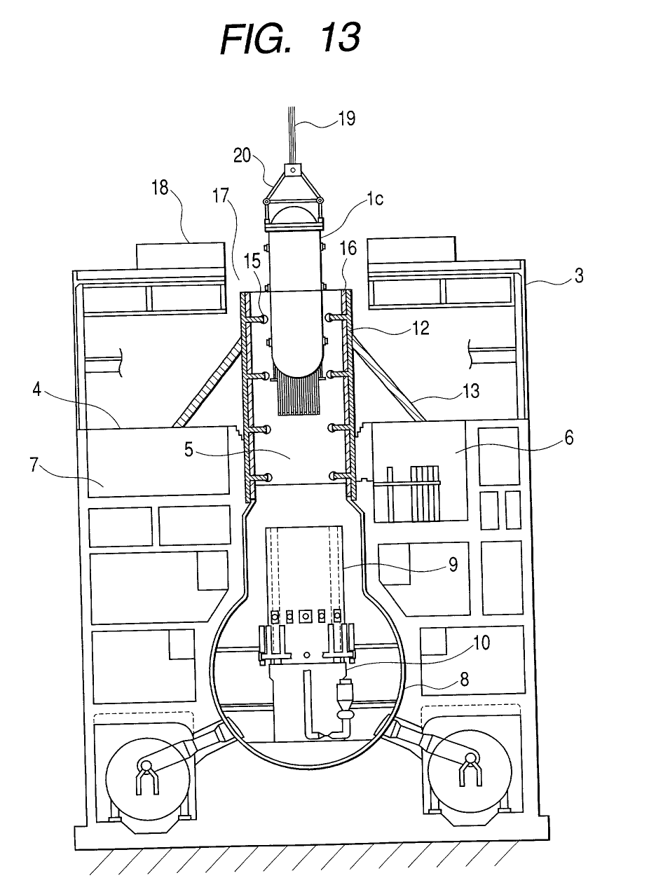

Subsequently, in step S10 in FIG. 1, a new RPV is hanged up and is carried in into the nuclear reactor building 3. FIG. 13 is a schematic vertical cross sectional view of the nuclear reactor building 3 showing a state where a new RPV 1e is carried in into the nuclear reactor building 3. In this instance, the new RPV 1e is hanged up by making use of the large scale crane 19 and is carried in through the temporary opening portion 17 and into the nuclear reactor building 3 and is disposed at a predetermined position in the RSW 9. By adjusting the length of the guides 15 provided at the protective wall 12 so as to meet the new RPV 1e, the new RPV 1e can be safely carried in under a stable condition like the carrying out time.

During this carrying in work, if the new RPV 1e drops into the nuclear reactor well 5, the new RPV 1e drops onto the upper portion of the pedestal 10 through the RSW 9 by means of the protective wall 12 and guides 15. Accordingly, the new RPV 1e is prevented by the RSW 9 from falling toward the used fuel pool 6 and a possible damaging to the used fuel pool 6 can be avoided.

Subsequently, in step S11, the protective wall 12 for the used fuel pool 6 is removed and is carried out from the nuclear reactor building 3. In step S12, the temporary opening portion 17 on the roof of the nuclear reactor building (R/B) 3 is restored and closed. In step S13, the large scale crane 19 installed at the outside of the nuclear reactor building 3 is disassembled and removed.

Subsequently, in step S14, pipings to be connected to the new RPV 1e are restored. In step S15, the fuels in the used fuel pool 6 are loaded in the reactor core of the new RPV 1e. Finally, in step S16, the nuclear reactor is started by closing in parallel. With the above sequence, the exchange work of the RPV is completed.

When it is assumed that the RPV drops during carrying out/in of the RPV, the most serious problem is that the dropped RPV falls toward the used fuel pool to break down the same and to cause a damage to the stored fuels.

According to the present embodiment, even if the RPV 1 drops, the RPV 1 drops vertically inside the nuclear reactor well 5 onto the pedestal 10 by means of the protective wall 12 and the guides 15. Accordingly, a possible falling down of the RPV 1 toward the used fuel pool 6 is prevented and a possible damage to the used fuel pool 6 can be avoided.

Now, another exchanging method of RPV representing a second embodiment of the present invention will be explained. In the present embodiment, after hanging up the RPV once using the gravity center thereof as the hanging point, the hanging point is shifted from the gravity center and the RPV 1 is hanged up while inclining the same toward the opposite side from the used fuel pool 6. The inclination of the RPV 1 is performed in such a degree that when the RPV 1 is inclined, the part thereof never touches to the wall of the used fuel pool 6. Thereby, even if the RPV 1 drops, the RPV 1 never falls down onto the used fuel pool 6. Accordingly, a partition wall between the used fuel pool 6 and the nuclear reactor well 5 is never damaged, and the used fuel pool 6 and fuels stored therein can be protected.

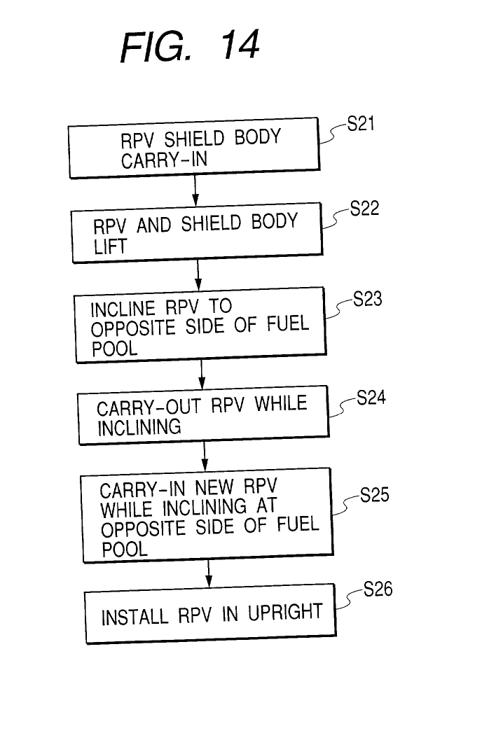

FIG. 14 is a flow chart showing a primary sequence of the RPV exchanging method of the second embodiment. The present flow chart is one that the steps S7-S11 in FIG. 1 are exchanged by steps S21-S26. Namely, after setting the temporary opening portion 17 at the nuclear reactor building 3 in step 6 in FIG. 1, in step S21 the RPV shield body 21 is carried in through the temporary opening portion 17 into the nuclear reactor building 3 and is temporarily placed on the upper portion of the RSW 9 in the PCV 8. In step S22, the RPV 1 and the RPV shield body 21 are hanged up together as explained above.

Thereafter, in step S23, under the condition that the RPV 1 is being hanged up, the hanging point of the RPV 1 is shifted from the gravity center thereof to thereby incline the RPV 1 toward the opposite side from the used fuel pool 6. In step S24, the RPV 1 and the RPV shield body 21 are hanged up in an inclined state and are carried out from the nuclear reactor building 3. FIG. 15 is a schematic vertical cross sectional view of the nuclear reactor building showing a state where the RPV 1 is being carried out while inclining the same toward the opposite side from the used fuel pool 6.

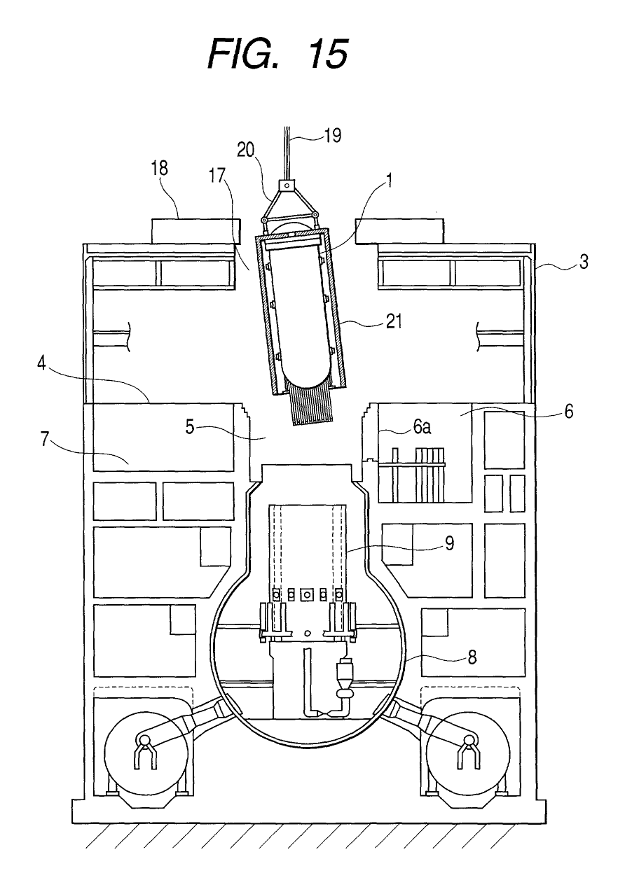

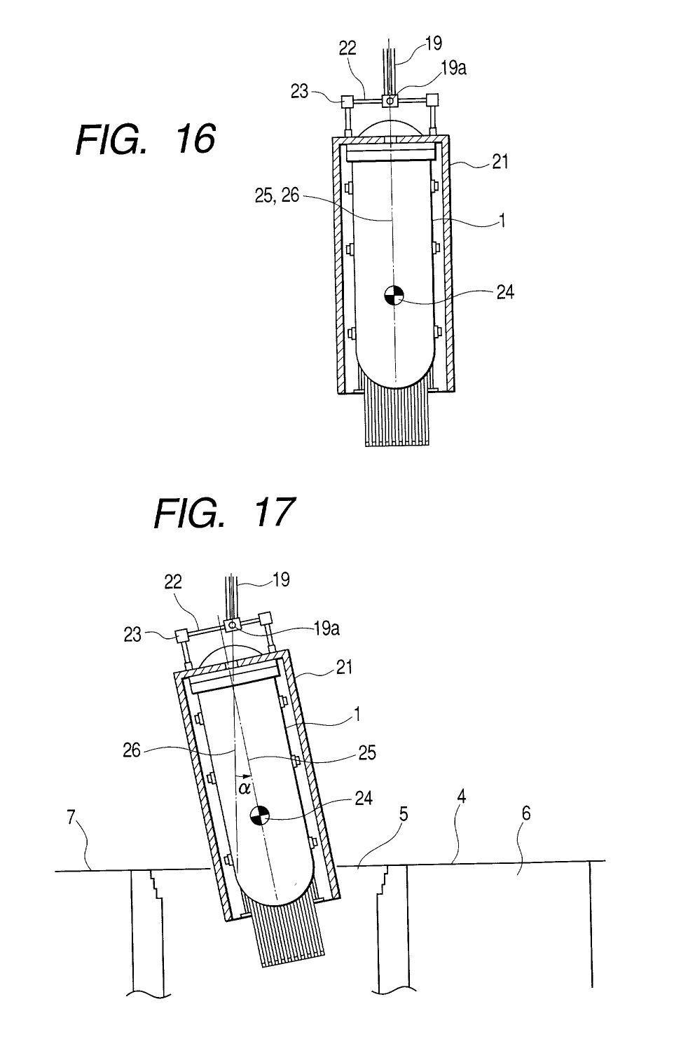

Other exemplary methods of inclining the RPV 1 toward the opposite side from the used fuel pool 6 will be explained with reference to FIGS. 16 through 22. FIGS. 16 and 17 are views for explaining a method of inclining the RPV 1 by making use of a hanging tool which permits displacement of the hanging point of the RPV 1.

FIG. 16 is a partial cross sectional view showing a state where the RPV 1 is hanged up at the vertical line of its center of gravity. 19a is a hanging point of the large scale crane 19, 22 is a union bolt, 23 is a motor for rotating the union bolts 22, 24 is the gravity center of the RPV 1, 25 is a center line of the RPV 1 passing through the center of gravity of the RPV 1 and 26 is a perpendicular line (a line in vertical direction). In this instance, the center line 25 and the perpendicular line 26 of the RPV 1 coincide each other.

FIG. 17 is a partial cross sectional view showing a state where the hanging point is displaced from the gravity center position toward the side of the used fuel pool 6 to incline the RPV 1. Under a condition where the RPV 1 is hanged up, through rotation of the union bolt 22 by the motor 23 the hanging point 19a is displaced from the gravity center position 24 (the center line 25 of the RPV 1) toward the side of the used fuel pool 6 to incline the RPV 1. In this instance the center line 25 of the RPV 1 is inclined by an angle α with respect to the perpendicular line 26.

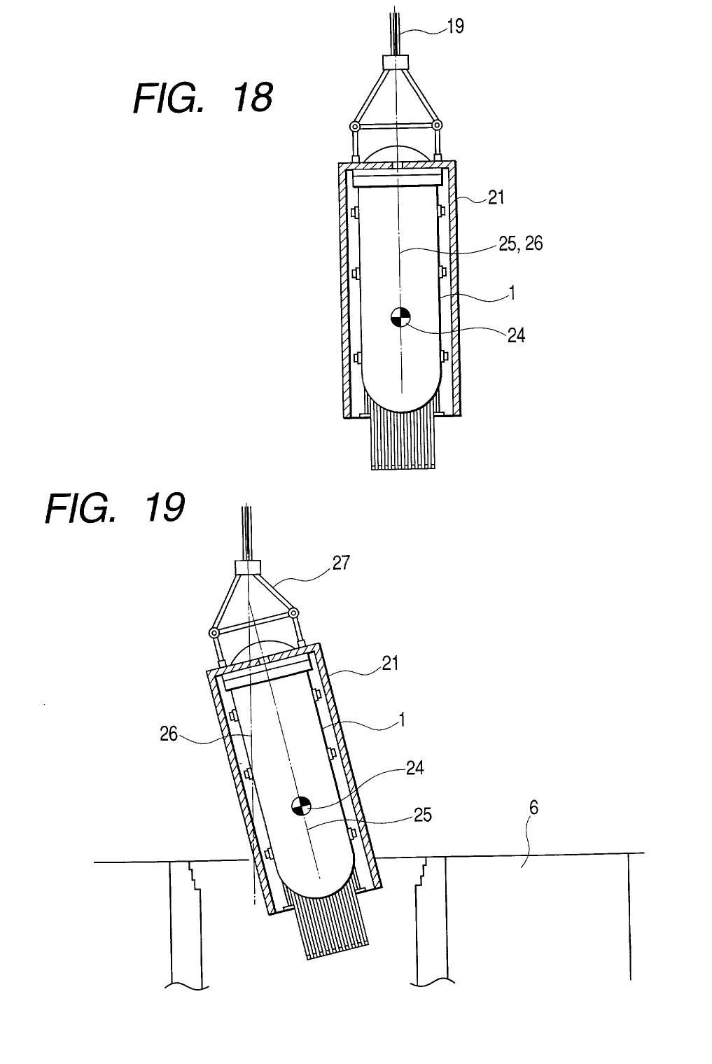

FIGS. 18 and 19 are views for explaining another method of inclining the RPV 1 using a device which permits adjustment of length of hanging tool at the side of the used fuel pool 6. FIG. 18 is a partial cross sectional view showing a state where the RPV 1 is hanged up above at the vertical center position 24 with hanging tool which permits to adjust the length of the hanging tool at the side of the used fuel pool 6. FIG. 19 is a partial cross sectional view showing a state where the length of the hanging tool at the side of the used fuel pool 6 is shortened to incline the RPV 1. Under the conditions that the RPV 1 is being hanged up, when the hanging tool (such as wires) 27 at the side of the used fuel pool 6 is shortened by making use of a device such as a winch and a motor, the RPV 1 can be inclined toward the opposite side from the used fuel pool 6.

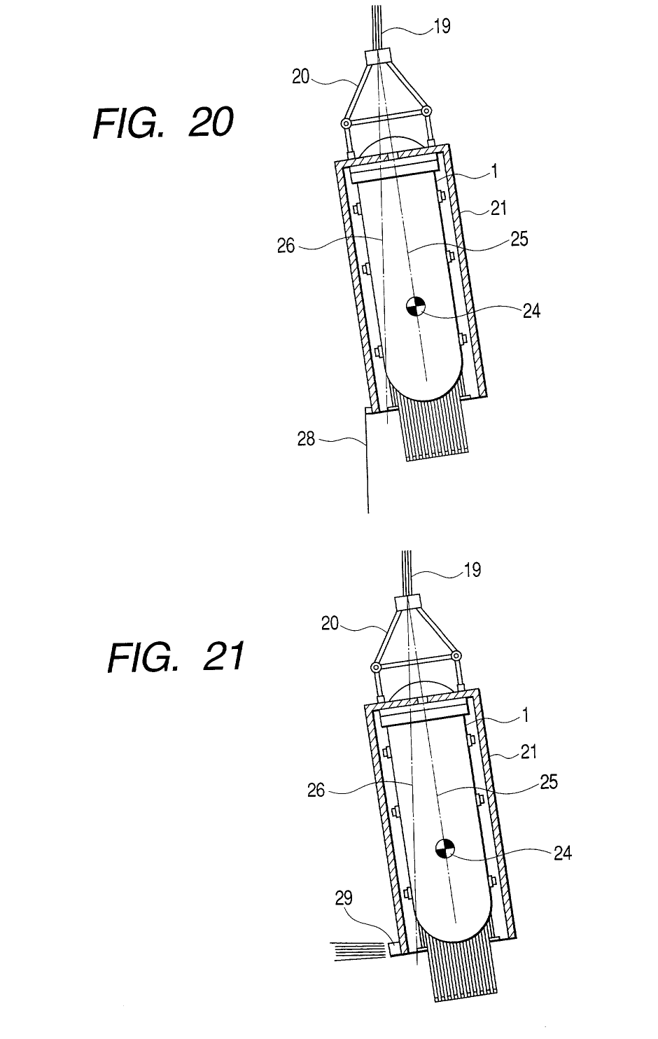

FIG. 20 is a view for explaining still another method of inclining RPV 1 in which under the condition that the RPV 1 is being hanged up a position offset from the gravity center position of the RPV 1 is pulled downward by making use of such as a wire. In this instance, when the pulling position of the wire 28 is selected to be toward the opposite side of the used fuel pool 6 from immediately below the gravity center position 24 of the RPV 1, the RPV 1 can be inclined to the opposite side from the used fuel pool 6.

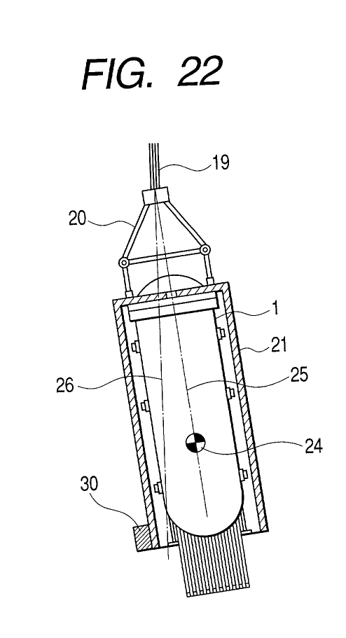

FIG. 22 is a view for explaining a further method of inclining the RPV 1 in which under the condition where the RPV 1 is being hanged up gas (such as air) is injected from a lower position of the RPV 1 which is offset from the gravity center position of the RPV 1. In this instance, a gas injection device 29 is provided at the opposite side of the used fuel pool 6 from the immediately below the gravity center position 24 of the RPV 1 and is caused to inject gas, thereby, the RPV 1 can be inclined to the opposite side of the used fuel pool 6.

FIG. 22 is a view for explaining a still further method of inclining the RPV 1 in which a weight is attached only to one side of the RPV 1 and the gravity center position of the RPV 1 and the RPV shield body 21 is offset from the center position of the RPV 1. In this instance, when a weight 30 is attached on the center face of the RPV shield body 21 at the opposite side from the used fuel pool 6, the RPV 1 can be inclined toward the opposite side from the used fuel pool 6. As alternatives, when the side of the RPV shield body 21 opposite from the used fuel pool 6 is formed heavier or a shield material is filled in the side of the RPV 1 opposite from the used fuel pool 6, substantially the same effect as above can be obtained.

Subsequently, in step S25, a new RPV 1e is carried into the nuclear reactor building 3 under the condition that the new RPV 1e is inclined toward the opposite side from the used fuel pool 6. As a method of inclining the new RPV 1e one of the methods as explained above can be used. In step S26, the new RPV 1e is positioned in an up right and is disposed at a predetermined potion on the pedestal 10, The sequence thereafter is identical as that after step S12 in FIG. 1.

In the present embodiment, since the RPV is carried out/in under the condition that the RPV is inclined toward the opposite side from the used fuel pool, even if the RPV drops, the RPV is prevented to fall down to the side of the used fuel pool, thereby, the use fuel pool can be protected.

Now, still another method of exchanging an RPV representing a third embodiment of the present invention will be explained. In the present embodiment, the temporary opening portion provided in the nuclear reactor building and for carrying out/in the RPV is expanded toward the opposite side from the used fuel pool so as to form a carrying out/in route away from the used fuel pool.

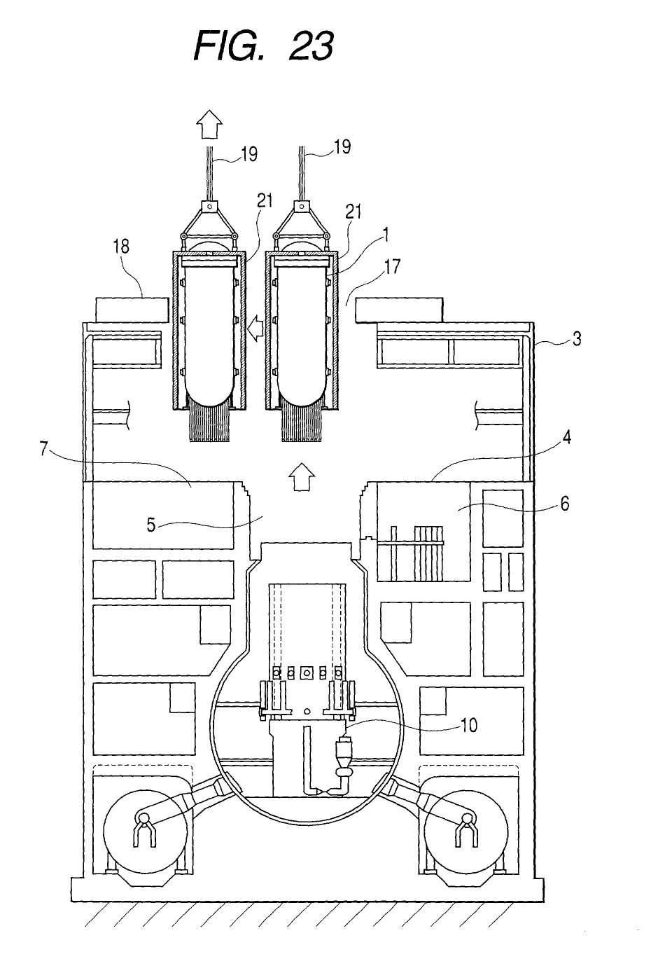

FIG. 23 is a schematic vertical cross sectional view of the nuclear reactor building showing a state where a RPV is now being carried out through the temporary opening portion expanded toward the opposite side from the used fuel pool via a carrying out route away from the used fuel pool. At first the RPV 1 separated from the pedestal 10 is hanged up higher than the operation floor 4 together with the RPV shield body 21. Subsequently, the RPV 1 is displaced horizontally toward the side of the machine and apparatus pool 7 opposite from the used fuel pool 6, and at a position where even if the RPV 1 drops no influence is affected to the used fuel pool 6, the RPV 1 is further hanged up and is carried out from the temporary opening portion of the nuclear reactor building 3.

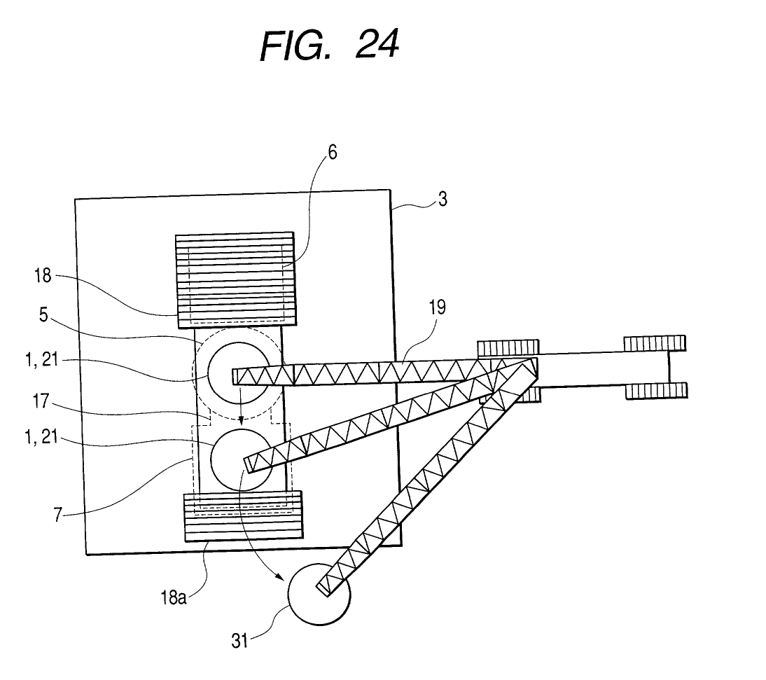

FIG. 24 is a plane view of the nuclear reactor building showing the carrying out route of the RPV 1. As shown in the drawing, the large scale crane 19 is installed in such a position 31 outside the nuclear reactor building 3 where the RPV 1 is hanged down is set at the side of the machine and apparatus pool 7, and the RPV 1 can be carried out without routing over the used fuel pool 6. Under these positional relationships, the RPV 1 is carried out as shown in FIG. 23. A carrying in a new RPV can be performed through a reverse sequence as that of the carrying out.

In the present embodiment, since the RPV 1 is displaced via the carrying out/in route away from the used fuel pool 6, even if the RPV drops, a probability (possibility) of falling down of the RPV 1 toward the used fuel pool 6 can be reduced and the used fuel pool 6 can be protected.

By means of the above respective embodiments and combination thereof, even if it is presumed that an RPV drops at the time during carrying out/in thereof, a possible falling down of the RPV toward the used fuel pool can be prevented to thereby protect the used fuel pool. Accordingly, a safety of the RPV exchanging work can be further enhanced.

Further, since the safety of the used fuel pool can be ensured, which dispenses with a possible displacement of the fuels in the used fuel pool to the outside of the nuclear reactor building. Therefore, the time required for the fuel displacement can be reduced and an operation stopping of a nuclear power plant caused in association with such as an RPV exchange work and an internal reactor structural body exchange work can be shortened.

Further, in the above embodiments, applications of the present invention to the RPV exchange works are explained. However, the present invention, of course, can be applied to an RPV carrying out work at the time when the reactor is removed. Further, the present invention can be applied, for example, to an exchange work of an internal reactor structural body such as a shroud with the same advantages.

According to the present invention, during exchange work of a large scale structural body such as the RPV and the internal reactor structural body, even if it is presumed that a large structural body drops, the used fuel pool and the fuel stored therein can be protected. Thereby, the safety of the exchange work can be further enhanced.

Further, since the safety of the used fuel pool can be ensured, which dispenses with a possible displacement of the fuels in the used fuel pool to the outside of the nuclear reactor building. Therefore, the time required for the fuel displacement can be reduced and an operation stopping of a nuclear power plant caused in association with such as an RPV exchange work and an internal reactor structural body exchange work can be shortened.

1. A method of treating a large scale structural body in which an opening portion is provided at a roof of a nuclear reactor building and the large scale structural body such as a nuclear reactor pressure vessel and an internal reactor structural body is carried out/in through the opening portion, wherein the carrying out/in of the large scale structural body is performed under a condition that a protective measure for a used fuel pool is provided in a nuclear reactor well.

2. A method of claim 1, wherein the protective measure is provided with a guide used for carrying out/in of the large scale structural body.

3. A method of claim 1, wherein the protective measure is a cushioning member for relaxing an impact of the large scale structural body.

4. A method of treating a large scale structural body in which an opening portion is provided at a roof of a nuclear reactor building and the large scale structural body such as a nuclear reactor pressure vessel and an internal reactor structural body is carried out/in through the opening portion, wherein the carrying out/in of the large scale structural body is performed under a condition that the large scale structural body is inclined toward the opposite side of a used fuel pool.

5. A method of claim 4, wherein a hanging position of the large scale structural body is displaced toward the side of the used fuel pool from the gravity center position of the large scale structural body so that the large scale structural body is inclined toward the opposite side from the used fuel pool.

6. A method of claim 5, wherein the large scale structural body is inclined toward the opposite side from the used fuel pool by making use of a hanging tool which permits displacement of the hanging position of the large scale structural body.

7. A method of claims 5, wherein the large scale structural body is inclined toward the opposite side from the used fuel pool by making use of a hanging tool which permits adjustment of the length of the hanging tool at the side of the used fuel pool.

8. A method of claim 5, wherein the large scale structural body is inclined toward the opposite side from the used fuel pool by pulling down such as with a rope of the large scale structural body at a position offset from the center line thereof.

9. A method of claim 5, wherein the large scale structural body is inclined toward the opposite side from the used fuel pool by injecting gas from a gas injection device provided at a side face of the large scale structural body.

10. A method of claim 5, wherein the large scale structural body is inclined toward the opposite side from the used fuel pool by attaching a weight on the large scale structural body at the opposite side from the used fuel pool.

11. A method of treating a large scale structural body in which an opening portion is provided at a roof of a nuclear reactor building and the large scale structural body such as a nuclear reactor pressure vessel and an internal reactor structural body is carried out/in through the opening portion, wherein the carrying out/in of the large scale structural body is performed through a route away from a used fuel pool while enlarging the opening portion from the upper portion of the nuclear reactor well toward the opposite side of the used fuel pool.

12. A method of any one of claims 1 through 11, wherein the carrying out/in of the large scale structural body is performed by making use of a large scale crane which is disposed outside the nuclear reactor building so that the large scale structural body never passes over the used fuel pool within the nuclear reactor building.
